(19) United States
(12) Patent Application Publication
(10) Pub. No.: US 2012/0251907 A1
(43) Pub. Date: Oct. 4, 2012

(54) METHOD FOR MANAGING A FUEL CELL DURING SULFUR COMPOUND POLLUTION, AND POWER SUPPLY DEVICE

(75) Inventors: Olivier Lemaire, Les Abrets (FR); Benoît Barthe, Chindrieux (FR); Alejandro Franco, Eybens (FR)

(73) Assignee: COMMISSARIAT A L'ENERGIE ATOMIQUE ET AUX ENERGIES ALTERNATIVES, Paris (FR)

(21) Appl. No.: 13/513,740

(22) PCT Filed: Dec. 3, 2010
(86) PCT No.: PCT/FR10/00806

§ 371 Date: Jun. 13, 2012

(30) Foreign Application Priority Data
Dec. 3, 2009 (FR) 0905845

(51) Int. Cl. H01M 8/06; H01M 8/04

(52) U.S. Cl. 429/427

(57) ABSTRACT

The method for managing a fuel cell having an active gas flowing in contact with an electrode includes a step of comparing the concentration of a sulfur compound in the active gas with a threshold indicative of a sulfur compound pollution phase and a step of temporary introducing an oxygenated and non-sulfur polluting gas into the active gas if the concentration is higher than the threshold. The polluting gas can be introduced during or after the pollution phase.

### BACKGROUND OF THE INVENTION

The invention relates to a management method for managing a fuel cell comprising an active gas flowing in contact with an electrode.

The invention also relates to a power supply device comprising a fuel cell.

### State of the Art

Fuel cells are electrochemical systems hat enable chemical energy to be converted into electricity. For Proton Exchange Membrane Fuel Cells (PEMFC), the chemical energy is for example in the form of gaseous hydrogen. The fuel cell is divided into two compartments separated by a proton exchange membrane. One of the compartments is supplied for example with hydrogen or methanol, called fuel gas, and the other compartment is supplied with oxygen or air, called oxidizing gas. On the anode, the oxidation reaction of hydrogen produces protons and electrons. The protons pass through the membrane whereas the electrons have to pass through an external electric circuit to reach the cathode. The reduction reaction of oxygen takes place on the cathode in the presence of protons and electrons.

The core of the cell, also called membrane-electrode assembly (MEA), is formed by catalytic layers and by the separating membrane. The catalytic layers are the location of the oxidation and reduction reactions in the cell. Gas diffusion layers are arranged on each side of the MEA to ensure electric conduction, homogeneous gas inlet and removal of the water produced by the reaction and of the non-consumed gases.

Pollution of the fuel and oxidizing gases is one of the main factors responsible for degradation of the performance of a PEM fuel cell. The impurities contained in hydrogen (fuel gas) are for example carbon oxides CO and CO₂, sulphur compounds (H₂S in particular) and ammoniac NH₃. These impurities originate in particular from the hydrogen fabrication method. Pollutants of air or oxygen (oxidizing gas) are for example nitrogen oxides NOₓ, sulphur oxides SOₓ and carbon oxides COₓ. These pollutants generally originate from automobile vehicle exhausts, and industrial and military sites.

These contaminants can penetrate into the chemical reaction areas of the cell and fix themselves on the catalytic sites of the anode and of the cathode. The catalytic sites are then poisoned and no longer participate in the oxidation and reduction processes. The contaminants further modify the structure and the properties of the core of the cell, for example modifying its hydrophobic or hydrophilic nature.

Thus, the degradation of the performance of the cell is therefore mainly due to reduction in the catalytic activity, to the heat loss following the increase of the resistance of the cell components and to the mass transport losses following variations of the structure. Among the oxidizing gas pollutants set out above, sulphur oxides (SOₓ, in particular sulphur dioxide SO₂, are particularly harmful and greatly impair the performance of the cell.

Different electrochemical methods are used to regenerate the performance of a fuel cell after a pollution episode by a sulphurated compound. These methods consist in applying an electric current or an electric pulse to each of the contaminated electrodes in order to remove the impurities from their surfaces. Another method consists in imposing a voltage which varies in cyclic manner between −1.5V and 1.5V. These regeneration techniques allow retrieving a satisfactory level of performance. Such techniques do however require the cell to be powered-off. Although it can be for a brief period, shutdown of the cell is detrimental to the device supplied by the cell. Moreover, the application of an electrical current in the form of a pulse or a cycle can degrade the components of the core of the cell, in particular the catalyst. These techniques are thus not suitable.

### Object of the Invention

The object of the invention is a method for managing a fuel cell that is simple and easy to implement and that enables a good performance to be restored after a sulfur compounds pollution.

According to the invention, this objective tend to be satisfied by the fact that the concentration of a sulfur compound in the active gas is compared with a threshold indicative of a sulfur compound pollution phase and by the fact that an oxygenated and non-sulfur polluting gas is temporarily introduced into the active gas if the concentration of sulfur compound is higher than the threshold.

A further object of the invention is a power supply device comprising means for comparing the concentration of a sulfur compound in the active gas with a threshold indicative of a sulfur compound pollution phase, a source of oxygenated and non-sulfur polluting gas and means for introducing the polluting gas into the active gas if the concentration of the sulfur compound is higher than the threshold.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents time variations of the voltage at the terminals of a cell, according to the concentration of a sulfur compound,

FIG. 2 schematically represents the time variations of the performance of a cell, in a first embodiment of a method for managing according to the invention,

FIG. 3 schematically represents the time variations of the performance of a cell, in a second embodiment,

FIG. 4 schematically represents the time variations of the performance of a cell, in a variant of the embodiment of FIG. 3,

FIGS. 5 and 6 represent the time variations of the voltage at the terminals of a cell, for a sulfur compound concentration of 1.5 ppm,

FIG. 7 represents the time variations of the voltage at the terminals of a cell, for a sulfur compound concentration of 4 ppm, and

FIG. 8 represents a power supply device according to the invention.

### DESCRIPTION OF PARTICULAR EMBODIMENTS

The article “The effect of ambient contamination on PEMFC performance” (Jing et al., Journal of Power Sources, 166, 172-176, 2007) describes the mechanism of pollution of oxidizing gas by sulfur dioxide SO₂. Some air containing sulfur dioxide is injected into the cell in order to determine the impact of such a pollution on the performance. The sulfur dioxide is adsorbed onto the catalyst layer made from platinum, thus reducing the active surface and consequently the catalytic activity. The performance of the cell decreases by about 35% after a pollution for approximately 100 hours and the restoring rate is about 84%.

The experiment is repeated with another pollutant of the oxidizing gas: nitrogen dioxide NO₂. in the same way, the nitrogen dioxide is fixed to catalytic sites and reduces the performance of the cell by 10% after a pollution for approximately 100 hours and the restoring rate is about 94%.

A third experiment is carried out with an oxidizing gas including nitrogen dioxide NO₂ and sulfur dioxide SO₂. The performance reduction is about 23% and the restoring rate is 94%. The adsorption of NO₂ and the adsorption of SO₂ by the catalyst would seem to be two competing mechanisms. Nitrogen dioxide is more easily adsorbed, which limits the adsorption of sulfur dioxide by the catalyst, which explains why the performance reduction is lower in the case of a mixture of the two pollutants than in the case of sulfur dioxide only. Nitrogen dioxide thus has an adsorption affinity on the catalyst higher than the affinity of sulfur dioxide.

It is proposed here to develop the teachings of this article to apply them in an advantageous way.

in the case of pollution by a sulfur compound having the chemical formula SXₙ, sulfur can be adsorbed by platinum according to the following simplified formula:

SXₙ+Pt

[symbol]

### =Xₙ+PtS

Sulfur is fixed to platinum and forms a compound having the formula PtS.

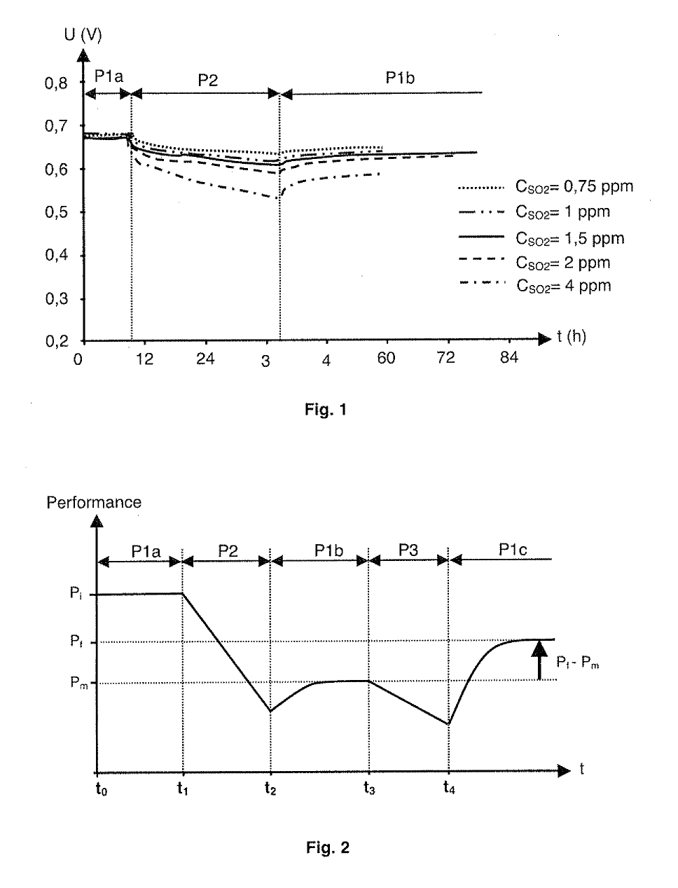

FIG. 1 represents the time (t) variation of the voltage U at the terminals of a PEM fuel cell in various cases of pollution. The phase P1a corresponds to an operating phase without pollutants. The voltage U is maximum in this phase.

The phase P2 corresponds to a pollution by a sulfurous compound, for example sulfur dioxide. The concentration in sulfur oxide SO₂ varies between 0.75 ppm (parts per million) and 4 ppm according to the various curves represented in FIG. 1. In this phase, the voltage U gradually drops.

It can be noticed in FIG. 1 that the reduction rate of the voltage increases as the concentration in pollutant increases. For example, the voltage decreased by approximately 40 mV at the end of the phase P2, for a SO₂ concentration of 1 ppm whereas for a concentration of 4 ppm, the reduction is approximately 150 mV. At the end of the pollution phase P2, the active gases become again pure (phase P1b) and the voltage U increases. Nevertheless, the voltage U does not completely rise to its initial level. Indeed, part of the active sites is irreversibly poisoned by the sulfur compound. A method for regenerating the performance of the cell must be employed.

The inventors have discovered that some oxygenated compounds, nitrogen dioxide NO₂ and carbon dioxide CO₂ in particular, can replace the sulfur element occupying the catalytic sites and responsible for the reduction in the cell performance, the voltage for example. This phenomenon is explained by the fact that these oxygenated compounds have an adsorption affinity higher than the sulfur compounds, as described previously. The mechanism is described, in a simplified way, by the following equation, in the case of NO₂:

PtS+NO₂+Pt

[symbol]

### NOPt+PtO+S

The sulfur element is replaced at the contaminated catalytic site (PtS) by the radical NO from NO₂.

In the case of CO₂, it is the radical CO that moves the sulfur element according to the reaction:

Pts+CO

[symbol]

### =COPt+S

It is proposed a method for managing a fuel cell using this phenomenon. Such a method comprises the detection of a sulfur compound pollution and the introduction of a recovery gas during or after this phase of pollution. This oxygenated and non-sulfur recovery gas will allow the outflow of the sulfur-containing particles poisoning the catalytic sites. The so-called recovery gas is a gas allowing a better regeneration of the performance of the cell at the time of a return to pure active gases after the sulfur compound pollution. Indeed, the catalytic sites will be released in greater quantity and the performance will rise to a higher level. That is explained by the fact that the oxygenated radicals are more easily desorbed than sulfur at the time of the return to pure active gases.

The fuel cell traditionally comprises two active gases: an oxidizing gas, air for example, and a fuel gas, hydrogen for example. Each of active oxidizing and fuel gases flows in contact with an electrode, respectively a cathode and an anode. As soon as a sulfur compound is detected in one of the active gases, a phase of pollution is identified. This detection can be carried out by comparing the concentration of the sulfur compound in the active gas with a threshold indicative of a phase of sulfur compound pollution. The sulfur compound is for example sulfur dioxide SO₂, generally present in the air, or hydrogen sulfur H₂S generally present in the fuel gas. The method for managing the cell is applied to sulfur compounds likely to be adsorbed by the catalyst, on the anode side as well as on the cathode side.

The recovery gas is then temporarily introduced into the polluted active gas if the concentration in sulfur compound is higher than the threshold. The threshold is preferably defined relative to the degradation of performance due to pollution. For example, a 10% reduction in performance due to pollution can provide the value of a first threshold. The recovery gas can be selected among nitrogen oxides NOₓ and carbon oxides COₓ, which are themselves common pollutants of PEMFC cells. Thus, the introduction of such a gas will be able, in the short run, to worsen the drop in performance due to the sulfur compound, but at the time of the return to pure active gases, the gas will have contributed to a higher regeneration of the cell performance. The duration of the introduction of the recovery gas is preferably comprised between 1 minute and 10 hours and can vary according to the desired level of final performance. The duration of the introduction can also depend on the quantity of recovery gas. For example, it can vary from a few minutes, for a recovery gas concentration of about some parts per million (ppm), to a few hours for a concentration of about some parts per billion (ppb). The quantity of recovery gas is preferably comprised between 10 parts per billion and 10 parts per million relative to the total quantity of gases, i.e. the active gas, the polluting gas and the recovery gas.

FIG. 2 represents the time variation of the performance of a cell according to a first embodiment of the management method. An unintentional pollution phase P2 follows a first pollutant-free phase P1a. The presence of a sulfur compound is detected between times t₁ and t₂. Between time t₂ and time t₃, the cell works again with pure active gases (phase P1b). The performance slightly increases and reaches an intermediate value Pₘ, lower than the initial performance Pᵢ. The recovery gas is intentionally introduced at the time t₃, corresponding to the recovery phase P₃. The performance decreases again. Indeed, the gas introduced is also polluting. However, after stopping the introduction of the recovery gas, the performance rises again, during a non-polluting phase P1c, to a value P_{f} higher than the value Pₘ of the performance after the phase of pollution P2. The introduction of the recovery gas during a phase P3 has thus allowed a performance improvement of P_{F}-Pₘ, represented by the arrow in FIG. 2.

In the embodiment of FIG. 2, the recovery gas is introduced after the sulfur compound pollution phase (P2) and a pollutant-free operating phase (P1b). In this case, the management method comprises a step in which the end of the pollution phase is detected and a step in which a time interval corresponding to the phase P1b is waited for.

In an alternative embodiment, the recovery gas is immediately introduced after detecting the end of the sulfur compound pollution phase P2. In this case also, the final performance is improved compared to the performance without using a recovery gas.

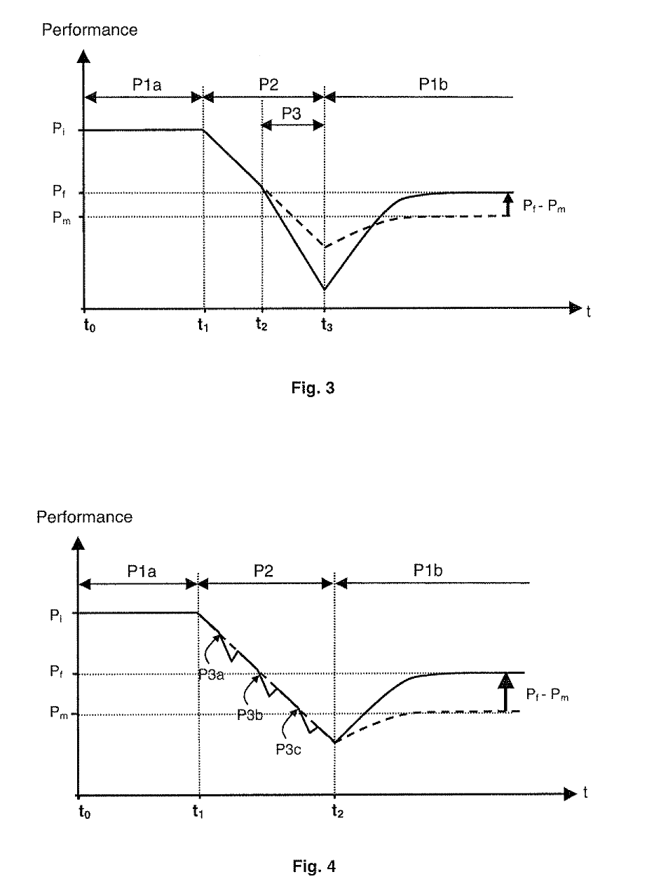

FIG. 3 represents a second embodiment in which the recovery gas is introduced during the phase of pollution by the sulfur compound. The curve in solid line represents the case of a management method with the introduction of a recovery gas while the curve in dotted lines represents the case of a method without the introduction of recovery gas. The sulfur compound pollution takes place between times t₁ and t₃. At time t₂ between t₁ and t₃, the recovery phase P3 starts. The performance decreases then more (solid line).

However, at the time of the return to pure active gas, i.e. in the phase P1b, the performance rises to a level P_{f} higher than that obtained without a recovery gas (dotted lines, level Pₘ).

FIG. 4 represents a variant of the method in FIG. 3. The gas is introduced during the pollution phase P2, between times t₁ and t₂, during several disjoint time intervals. In the example of FIG. 4, three recovery phases P3a to P3c are used. The duration of the introduction of the recovery gas into each phase P3 is variable, just as the duration between two successive phases P3. This cutting is advantageous because it allows an intermediate analysis of the performance reduction in order to adjust the quantity of recovery gas to be introduced into the following phase P3. This quantity can be adjusted, for example, by modifying the number of phases P3 and the duration of each of them.

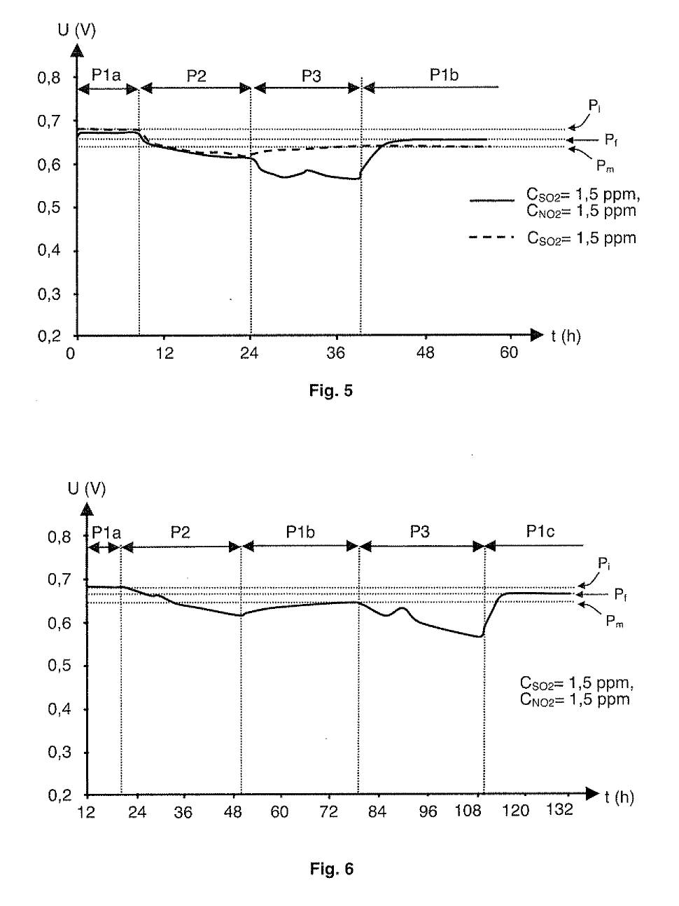

FIGS. 5 to 7 illustrate operation examples for a cell managed according to the various described embodiments of the management method. The operating conditions for this cell are as follows:

the electrodes are loaded with a catalyst, for example platinum, at about 0.5 mg/cm²;

the polymeric membrane is for example in a material registered under the trademark Nafion by the company DuPont and has a thickness of about 50 μm;

the water content of the reactive gases at the anode and at the cathode is approximately 60%;

the current density of the cell is about 0.6 A/cm²;

the polluting gas is the sulfur dioxide in the air;

the recovery gas is nitrogen dioxide.

FIG. 5 represents an operation example with a recovery phase P3 starting from the end of a pollution phase P2. The curve in solid line represents the case of a management method with the introduction of the recovery gas while the curve in dotted lines represents the case of a method without the introduction of the recovery gas (no phase P3 in this case). The sulfur dioxide pollution phase P2, at a concentration of 1.5 ppm, lasts approximately 15 hours. It is directly followed by a recovery phase P3 with nitrogen dioxide NO₂, at a concentration of 1.5 ppm. The nitrogen dioxide is introduced into the air for a length of time of approximate 15 hours.

Voltage is used as a parameter representative of the performance of the cell. The final voltage will then be noted P_{f}. In the same way, the voltage obtained without introducing the recovery gas is noted Pₘ. The improvement P_{f}-Pₘ obtained in term of voltage by the management method is about 17 mV.

FIG. 6 represents another example in which the introduction of the recovery gas NO₂ is carried out after a phase P2 of pollution by SO₂ for 30 hours at 1.5 ppm and a pollutant-free operating phase P1b for approximately 30 hours. The recovery phase P3 lasts approximately 30 hours. The improvement of the performance P_{f}-Pₘ corresponds to a voltage of 16 mV.

The management method with introduction of an oxygenated and non-sulfur recovery gas is applied whatever the concentrations in pollutants. The concentration of the recovery gas can also be adapted according to the desired improvement of the performance.

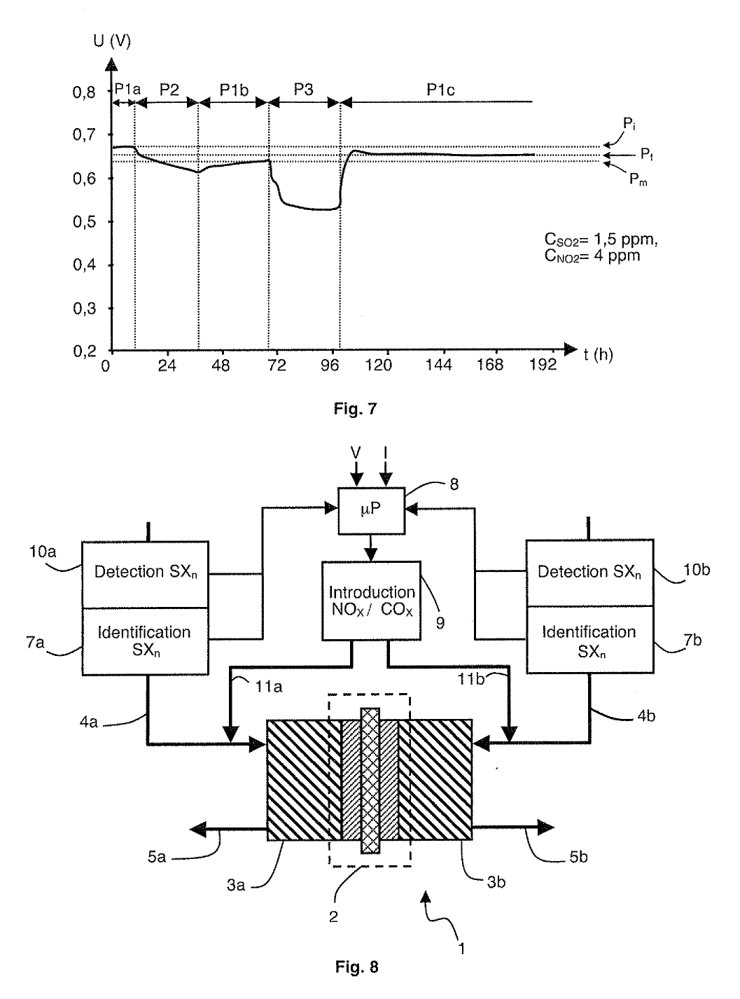

FIG. 7 represents an operation example with a NO₂ concentration of 4 ppm during the phase P3 and a waiting phase P1b between the end of the pollution phase P2 and the introduction of the recovery gas. The voltage P_{f} after the recovery phase P3 has increased by a value able to reach 22 mV relative to the voltage Pₘ obtained after the pollution phase P2.

This management method with introduction of a recovery gas will be preferably applied as long as the performance will be higher than 50% of the initial performance.

In order to implement this management method, a power supply device comprises means for comparing the concentration of a sulfur compound in the active gas with a threshold indicative of a phase of pollution by the sulfur compound and means for introducing an oxygenated and non-sulfur recovery gas into the active gas if the concentration in the sulfur compound is higher than the threshold. The device will then be able to automatically control the introduction of the recovery gas according to the most adapted mode of regeneration.

The supply device moreover comprises means for identifying the sulfur compound and calculation means for calculating the quantity of recovery gas to be introduced. The calculation means will also be able to determine the degradation rate of the performance, the level of the performance, the duration of the introduction of the gas. The calculation means will thus determine the adequate mode of introduction and will control the means for introducing the recovery gas according to, for example, the nature of the pollutant and/or the degradation rate of the performance.

FIG. 8 represents an example of supply device. The device comprises a fuel cell 1 provided with a proton exchange membrane (PEMFC). The cell 1 includes a membrane-electrode assembly (MEA) 2, forming the core of the cell, and gas diffusion layers 3a and 3b on both sides of the assembly 2. Each gas diffusion layer (3a, 3b) includes an active gas input and an output for the gas in excess and the reaction products, respectively 4a and 5a for the fuel gas on the left in FIGS. 8, and 4b and 5b for the oxidizing gas on the right in FIG. 8.

Moreover, the device 1 comprises a detector 7 for sulfur compounds SXₙ. The detection can consist in comparing the concentration in the sulfur compound with a threshold indicative of a pollution. In FIG. 8, the supplying device comprises two detectors 7a and 7b, respectively for the fuel gas and the oxidizing gas. An electronic control circuit 8, for example a microcontroller, allows to determine the variation of the cell performance, in particular from the measured values of voltage (V) and current (I). Control circuit 8 is connected to the output of detectors 7a and 7b for controlling an inlet valve 9 of the recovery gas, COₓ or NOₓ for example. Control circuit 8 is also connected to means 10a and 10b for identifying the polluting gas. The identification means 10a and 10b can be incorporated into the polluting gas detectors 7a and 7b. The recovery gas is introduced into the active fuel gas by means of a conduit 11a and/or into the oxidizing active gas by means of a conduit 11b. The conduits 11a and 11b are connected to the active gases inputs of the cell, respectively 4a and 4b.

The method for managing a fuel cell is also applied if the two compartments, for the fuel and oxidizing gases, are simultaneously polluted by the same gas or by different gases. A recovery gas is then injected into each compartment. The recovery gases can be identical or of different nature on the combustible side and the oxidizing side. Finally, several recovery gases can be employed successively.

1.-10. (canceled)

11. A method for managing a fuel cell comprising an active gas flowing in
contact with an electrode, comprising the following steps:
comparing a concentration of a sulfur compound in the active gas with a threshold indicative of a sulfur compound pollution phase, and
temporarily introducing into the active gas an oxygenated and non-sulfur polluting gas if the concentration of the sulfur compound is higher than the threshold.

12. The method according to claim 11, wherein the polluting gas is selected among nitrogen oxides and carbon oxides.

13. The method according to claim 11, wherein the polluting gas is introduced during the sulfur compound pollution phase.

14. The method according to claim 13, wherein the polluting gas is introduced during several disjoint time intervals.

15. The method according to claim 11, wherein the polluting gas is introduced after the sulfur compound pollution phase.

16. The method according to claim 15, comprising, before the step of
introducing the polluting gas, the following steps:
detecting an end of the sulfur compound pollution phase, and
waiting for a time interval.

17. (canceled)

18. The method according to claim 11, wherein the quantity of polluting gas is comprised between 10 parts per billion and 10 parts per million relative to the
total quantity of gases.

19. A power supply device comprising:
a fuel cell comprising an active gas flowing in contact with an electrode,
a comparator of the concentration of a sulfur compound in the active gas with a threshold indicative of a sulfur compound pollution phase,
a source of oxygenated and non-sulfur polluting gas, and
an inlet introducing the polluting gas into the active gas if the concentration in the sulfur compound is higher than the threshold.

20. The power supply device according to claim 19, further comprising:
an identification device of the sulfur compound, and
a calculator of the quantity of polluting gas to be introduced.

21. The method according to claim 11, wherein the duration of the introduction of the polluting gas is comprised between 1 minute and 10 hours.
